(19) United States
(12) Patent Application Publication
(10) Pub. No.: US 2009/0238124 A1
(43) Pub. Date: Sep. 24, 2009

(54) METHOD AND APPARATUS FOR COMBINED MEDIUM ACCESS CONTROL AND RADIO LINK CONTROL PROCESSING

(75) Inventors: Ravikumar V. Pragada, Collegeville, PA (US); Edward L. Hepler, Malvern, PA (US); Jean-Louis Gauvreau, La Prairie (CA); Paul Marinier, Brossard (CA); Jeffrey T. Davis, Doylestown, PA (US); Shiehlie Wang, Plymouth Meeting, PA (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 12/267,105

(22) Filed: Nov. 7, 2008

Related U.S. Application Data
(60) Provisional application No. 60/986,367, filed on Nov. 8, 2007.

(51) Int. Cl. H04W 72/04

(52) U.S. Cl. 370/329

(57) ABSTRACT

A method and apparatus for combined medium access control (MAC) and radio link control (RLC) processing are disclosed. For uplink processing, a combined MAC/RLC (CMR) entity generates an SDU descriptor and allocates protocol data unit (PDU) descriptor resources. A protocol engine (PE) populates a PDU descriptor for each PDU carrying at least a portion of the SDU and generates a MAC PDU in a physical layer shared memory based on the SDU descriptor and the PDU descriptor. The MAC PDU is generated while moving RLC SDU data from the bulk memory to the physical layer shared memory. For downlink processing, received MAC PDUs are stored in the physical layer shared memory. The PE reads MAC and RLC headers in the MAC PDU and populates an SDU segment descriptor (SD) and corresponding PDU descriptors for each SDU segment. The CMR entity merges SDU SDs that comprise a same RLC SDU.

### CROSS REFERENCE TO RELATED APPLICATIONS

This application claims the benefit of U.S. provisional application No. 60/986,367 filed Nov. 8, 2007, which is incorporated by reference as if fully set forth.

### FIELD OF INVENTION

This application is related to wireless communications.

### BACKGROUND

In universal terrestrial radio access (UTRA) Release 6 systems, the radio link control (RLC) layer in acknowledged mode (AM) may only use a fixed protocol data unit (PDU) size. In addition, the high speed downlink shared channel (HS-DSCH) medium access control (MAC-hs) layer in the Node B may not segment medium access control (MAC) service data units (SDUs) from higher layers. It has been recognized that these restrictions may result in performance limitations especially as high speed packet access (HSPA) evolves towards higher data rates. Accordingly, in Release 7, flexible RLC PDU size and enhanced MAC-hs (MAC-ehs) segmentation capabilities has been introduced, and RLC PDU may be segmented over multiple MAC PDU and transmission time interval (TTI).

MAC-ehs segmentation introduced in Release 7 introduces additional considerations for combined RLC and MAC processing in a given TTI as RLC PDU segments may be sent over multiple TTIs. For example, an end-segment captured in a given TTI would have no RLC header.

However, combined RLC/MAC processing would be very efficient, as it allows parsing of the MAC and RLC headers in a single pass. Central processing unit (CPU) intensive processing at a PDU level is done only once. Therefore, an efficient method to allow combined MAC and RLC processing with MAC segmentation would be very desirable.

### SUMMARY

A method and apparatus for combined MAC and RLC (CMR) processing are disclosed. A wireless transmit/receive unit (WTRU) includes a bulk memory for storing an RLC SDU forwarded from a higher layer. For the uplink processing, a CMR entity generates an SDU descriptor for the SDU and allocates PDU descriptor resources for the RLC SDU. A protocol engine (PE) in the WTRU populates a PDU descriptor for each PDU carrying at least a portion of the SDU and generates a MAC PDU in a physical layer shared memory based on the SDU descriptor and the PDU descriptor. The MAC PDU is generated while moving RLC SDU data from the bulk memory to the physical layer shared memory. For the downlink processing, the received MAC PDUs are stored in the physical layer shared memory. The PE reads MAC and RLC headers in the MAC PDU and populates an SDU segment descriptor (SD) and corresponding PDU descriptors for each SDU segment included in the MAC PDU based on the MAC and RLC headers. The CMR entity merges SDU SDs with a segment flag other than “complete RLC PDU” that comprise a same RLC PDU, and merges SDU SDs with a segment flag of “complete RLC PDU” that comprise a same RLC SDU, and sends a complete RLC SDU to a higher layer.

### BRIEF DESCRIPTION OF THE DRAWINGS

A more detailed understanding may be had from the following description, given by way of example in conjunction with the accompanying drawings wherein:

FIG. 1 shows a universal mobile telecommunication systems (UMTS) access stratum (AS) protocol stack along with a protocol engine (PE);

FIG. 2 shows an example external memory used for packet switched data and an L1 shared memory;

FIG. 3 is a flow diagram of an example uplink transmit processing in accordance with one embodiment;

FIG. 4 shows generation of SDU descriptors;

FIG. 5 shows generation of example SDU and PDU descriptors and CMR/PE-Tx data handling;

FIG. 6 shows example processing of a control PDU received from the network;

FIG. 7 shows example processing of a subsequently received control PDU from FIG. 6;

FIG. 8 shows example processing of a control PDU for retransmission;

FIG. 9 shows example processing of SDU discard;

FIG. 10 is a flow diagram of an example receive process in accordance with one embodiment;

FIG. 11 shows the MAC-ehs PDU stored in the shared memory; and

FIG. 12 shows logic for setting a segment flag (SF).

### DETAILED DESCRIPTION

When referred to hereafter, the terminology “WTRU” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a Node-B, a site controller, an access point (AP), or any other type of interfacing device capable of operating in a wireless environment.

An MAC-ehs service data unit (SDU) is an MAC-d PDU or a MAC-c PDU. When a dedicated HS-DSCH radio network temporary identity (H-RNTI) is used, there is no MAC-d or MAC-c header, and a MAC-d PDU or a MAC-c PDU is equal to an RLC PDU, and therefore, a MAC-ehs SDU is also equal to an RLC PDU. Hereinafter, the term “MAC-ehs SDU” is equivalent to the term “RLC PDU” unless otherwise specified. A reordering SDU is either a complete MAC-ehs SDU or a segment of an MAC-ehs SDU. When a dedicated H-RNTI is used, a reordering SDU may be a complete RLC PDU or a segment of a RLC PDU. A reordering PDU comprises one or more reordering SDUs belonging to the same priority queue. Hereinafter, the term “SDU” when used in a stand-alone way refers to “RLC SDU”, and the term “MAC PDU” is equivalent to “MAC-ehs PDU”.

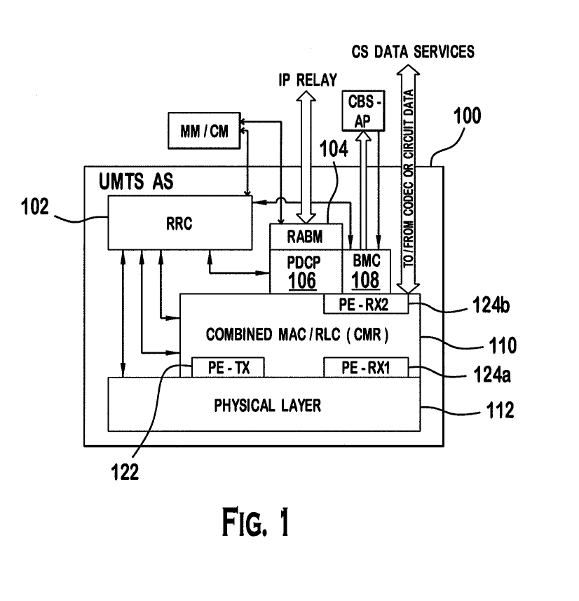

FIG. 1 shows a UMTS AS protocol stack 100 along with a protocol engine (PE). The UMTS AS 100 includes a radio resource control (RRC) entity 102, a radio access bearer management (RABM) entity 104, a packet data convergence protocol (PDCP) entity 106, a broadcast/multicast control (BMC) entity 108, a combined MAC/RLC (CMR) entity 110, and a physical layer 112.

The RRC entity 102 configures the CMR entity 110 and the physical layer 112 by sending configuration, reconfiguration, reset signals, etc. The RABM entity 104 performs radio access bearer (RAB) establishment and maintenance, (i.e., tear-down and re-establishment of an RAB). The PDCP entity 106 performs header compression and decompression. The BMC entity 108 controls reception of broadcast and multicast services.

The CMR entity 110 handles a control part of RLC and MAC processing. The CMR entity 110 allocates and de-allocates buffers from the resource pool. Majority of data aspects of RLC and MAC processing is performed by PEs, (i.e., a transmit PE 122 and a receive PE 124a, 124b). FIG. 1 also shows one transmit PE 122 and two receive PEs 124a, 124b, as an example, but one or more than one transmit and receive PEs may be used. The CMR entity 110 handles minor data aspects which are not part of PEs such as MAC-hs reordering, processing of RLC control PDUs, determining when SDUs can be built in downlink, or the like. The CMR entity 110 and the PEs 122, 124a, 124b work in a synchronous and pipelined way. This will avoid the need for completion interrupts, significant amount of messaging and task switches where possible.

It should be noted that the UMTS AS is illustrated as an example, and the embodiments disclosed herein are applicable to any other protocol stack, including an AS in a network side, a non-access stratum (NAS) in the WTRU and the network side, as well as any other wireless communication standards including, but not limited to, global standards for mobile communication (GSM), global packet radio services (GPRS), enhanced data rate for GSM evolution (EDGE), CDMA2000 and IEEE 802.xx, or the like.

Conventional protocol stack operations can be divided into two categories: 1) decision and control operations, and 2) data moving and re-formatting operations. Decision and control operations are involved in radio link maintenance, control and configuration. These operations are typically complex decision making processes and require significant flexibility in design and implementation. However, decision and control operations do not use significant processing power of standard processors. Data moving and re-formatting operations are involved in moving data between protocol stack components and re-formatting of data during the process. While the data moving and re-formatting operations are highly straightforward involving few decision points, these operations require significant processing power and the processing power increases as the data rate increases. The PE handles the data moving and re-formatting operations and those data moving and re-formatting operations are removed from the conventional protocol stack. The PE is implemented by a simple, (low complexity, low power consumption), programmable processor, (a microcontroller or generic processor), that interprets headers of a received data packet on the receive side and generates headers of a transmit data packet on the transmit side.

The CMR entity 110 and the PE are configured in such a way that both MAC and RLC headers are parsed (or constructed) in a single pass, move the data out of a physical layer shared memory (on-chip memory) to an external memory, (e.g., external synchronous dynamic random access memory (SDRAM)), (or vice versa) in a structured way mapped at RLC SDU or RLC SDU segment level and decipher (or cipher) the RLC PDU if necessary. Instead of or in addition to having an external memory, an on-chip bulk memory, (e.g., dynamic random access memory (DRAM)), may be embedded for the same purpose. The PE also supports the control side by parsing out the header on the downlink side and creating the header in the uplink side. The PE packages data and put header information into data structures so that re-ordering, etc. is easily performed.

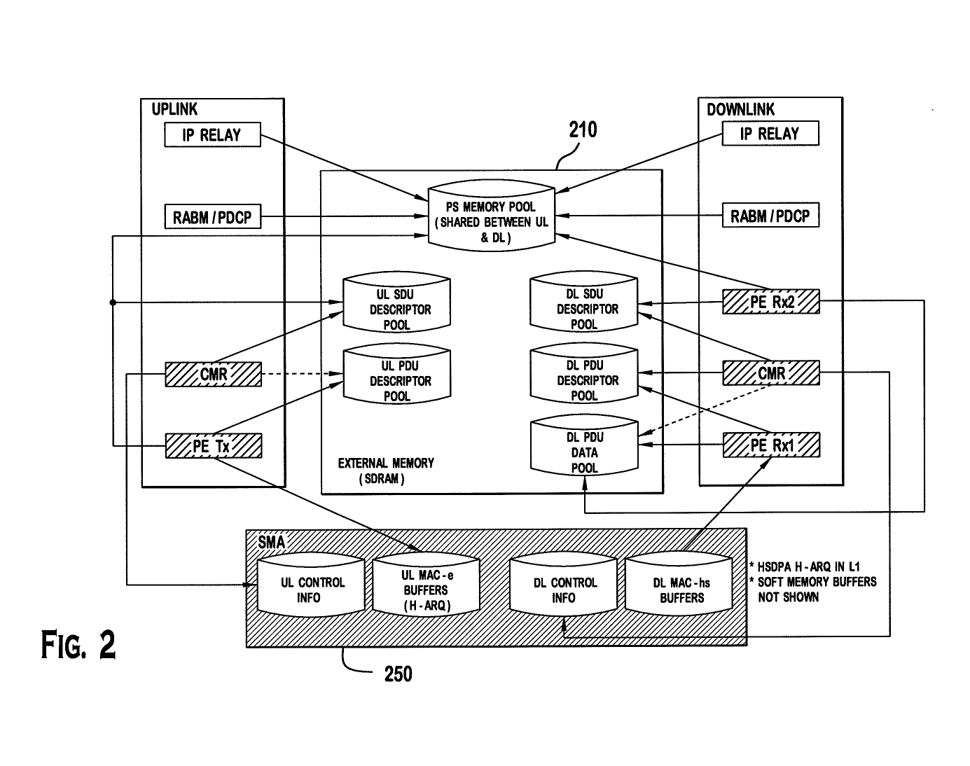

FIG. 2 shows an example external memory 200 used for packet switched data and a physical layer shared memory 250. The external memory 200 provides packet switched (PS) memory pool, uplink (UL) SDU descriptor pool, UL PDU descriptor pool, downlink (DL) descriptor pool, DL PDU descriptor pool, and DL PDU data pool. The PS memory pool is shared between UL and DL. A separate UL PDU data pool may not be necessary since in the UL there is only one copy within the system after an IP packet enters the system. Generated uplink MAC PDUs or received downlink MAC PDUs and uplink and downlink control information are stored in the physical layer shared memory.

It should be noted that FIG. 2 shows multiple instances of IP Relay and RABM/PDCP blocks only for simplification of the processing for UL versus DL. Dashed line indicates that the CMR touches the respective memory pool only for memory management purposes.

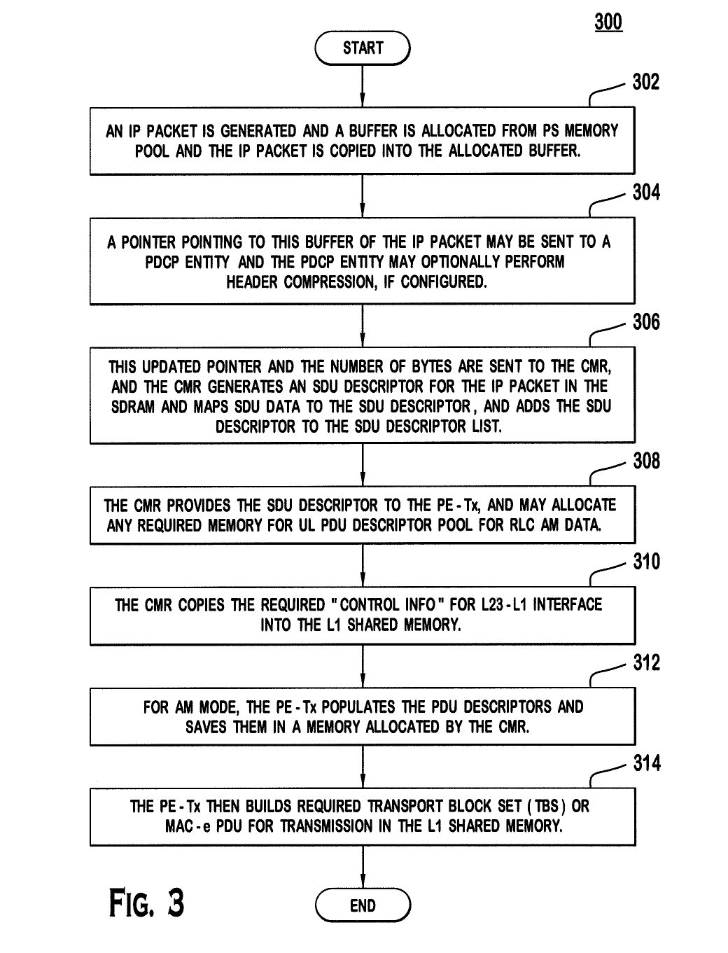

FIG. 3 is a flow diagram of an example UL transmit process 300 in accordance with one embodiment. An IP packet is generated and a buffer is allocated from PS memory pool and the IP packet is copied into the allocated buffer (step 302). A pointer pointing to this buffer of the IP packet may be sent to a PDCP entity and the PDCP entity may optionally perform header compression, if configured (step 304). The IP payload is not changed and only the header is compressed and the compressed header is over-written in front of the IP payload and the pointer is updated.

This updated pointer and the number of bytes are sent to the CMR, and the CMR generates an SDU descriptor for the IP packet, (i.e., SDU), in the SDRAM and maps SDU data, (i.e., the IP packet), to the SDU descriptor, and adds the SDU descriptor to the SDU descriptor list, which is a linked list (step 306).

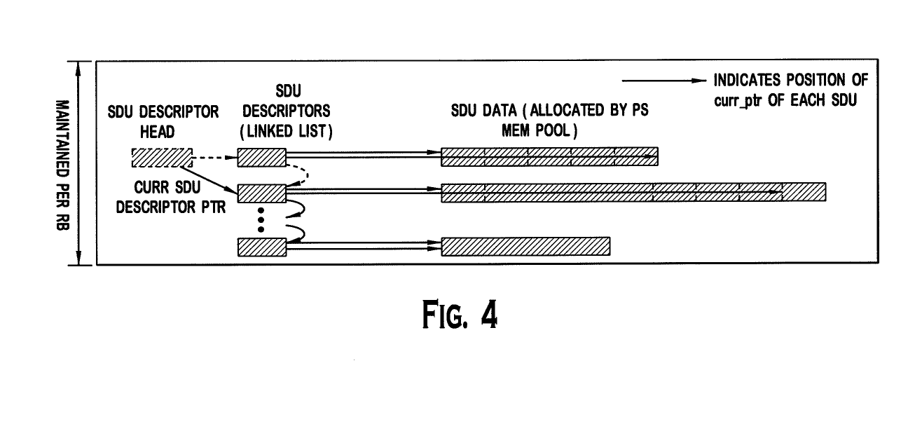

An SDU descriptor defines the details of the SDU, such as the current location in the SDU from where the data needs to be transmitted, PDUs that this SDU belongs to, information needed to communicate to higher layers regarding the SDU, etc. FIG. 4 shows generation of SDU descriptors. The SDU descriptor head is updated as a new SDU descriptor is added to the linked list of SDU descriptors. The SDU descriptor indicates the position of the SDU in the PS memory pool. The UL SDU descriptor may contain three pointers: one pointer points to the next “SDU descriptor” and two pointers into the SDU buffer, (i.e., one pointer to the beginning of the SDUs buffer and the other pointer to the data to be transmitted inside the buffer). SDU descriptor resources are allocated and de-allocated form a static pool of UL SDU descriptors.

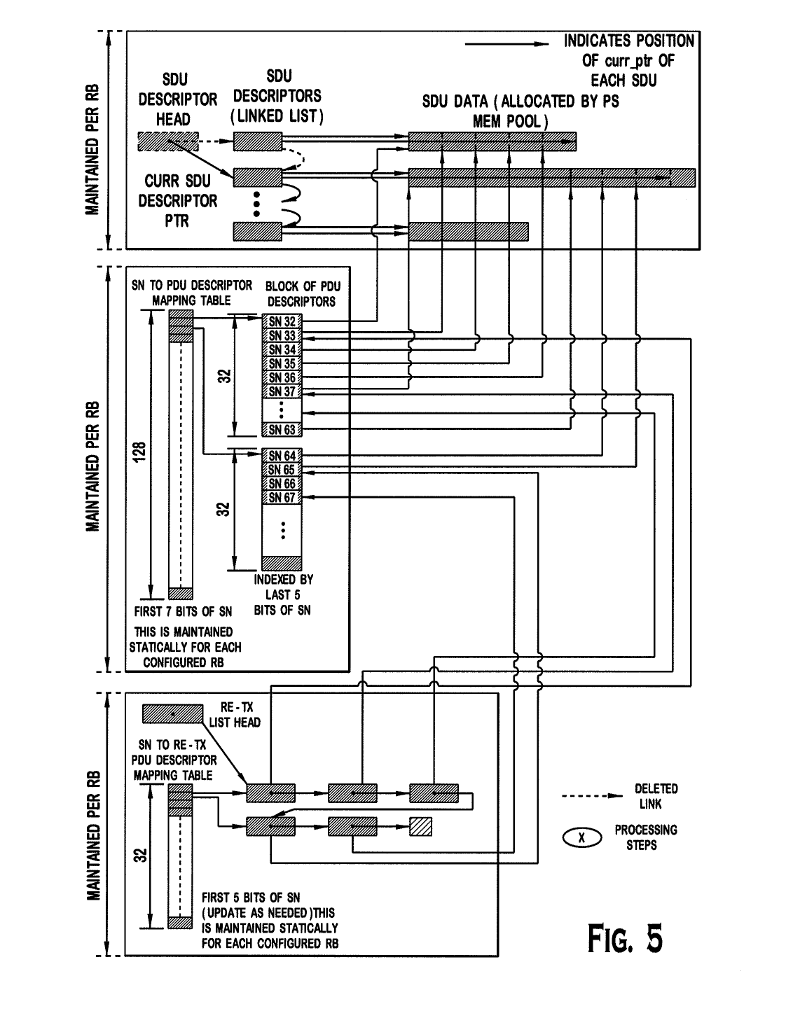

The CMR provides the SDU descriptor to the PE-Tx, and may allocate any required memory for UL PDU descriptor pool for RLC AM data (step 308). A PDU descriptor defines how PDUs should be built and also maintains relevant state information regarding the PDU (such as how many times a particular PDU may be transmitted and re-transmitted). The UL PDU descriptor (as shown in FIG. 5) contains a pointer to the data located in the SDU buffer. In UL, PDU descriptors are maintained only for RLC AM mode. For UM and TM modes, PDU descriptors exist temporarily as PDUs are built and are thrown away as soon as corresponding PDU is built. No storage for PDU descriptors is needed in UM and TM modes.

The CMR copies the required “control info” for L23-L1 interface into the L1 shared memory (step 310). For AM mode, The PE-Tx populates the PDU descriptors and saves them in a memory allocated by the CMR (step 312). The PE-Tx then builds required transport block set (TBS) or MAC-e PDU for transmission in the L1 shared memory (step 314).

The control information includes configuration information, data information, header building information, etc. The configuration information includes the number of radio bearers (RBs) configured and a list of RBs active in current TTI, for each RB, mode of RB, PDU size, LI size, location of PDU descriptor mapping table, ciphering information, VT(S), VT(A) or VT(US), RB to transport channel (TrCH) ID mapping, polling information, etc. The data information includes a pointer to control queue, the number of superfields (SUFIs) (only for AM), optionally total length in bytes; the pointer to Re-Tx queue, the number of PDUs to be retransmitted (only for AM); and the pointer to Tx queue, the number of of PDUs.

FIG. 5 shows generation of example SDU and PDU descriptors and CMR/PE-Tx data handling. The top box shows generation of SDU descriptors as explained in FIG. 4. Each SDU descriptor indicates the position of the SDU data in the PS memory pool. The middle box shows allocation of PDU descriptors and SN-to-PDU descriptor mapping. The PDU descriptor resource is managed dynamically by the CMR and shared by all RBs. For block memory management, a mapping table approach may be used. For example, PDU descriptor resources may be allocated in a block of 32 PDU descriptors and first 7 bits of 12 bit RLC SN may be used to map the block of PDU descriptors. This reduces the maintenance overhead of allocating and de-allocating each PDU descriptor from the UL PDU descriptor pool. PDU descriptors are de-allocated when the acknowledged SN is modulo 32. As shown in FIG. 5, each PDU descriptor indicates the position of the corresponding PDU in the PS memory pool. The bottom box shows SN-to-retransmit PDU descriptor mapping. A retransmission list of negatively acknowledged (NACKed) PDUs is separately maintained and each item in the retransmission list indicates the corresponding PDU descriptor.

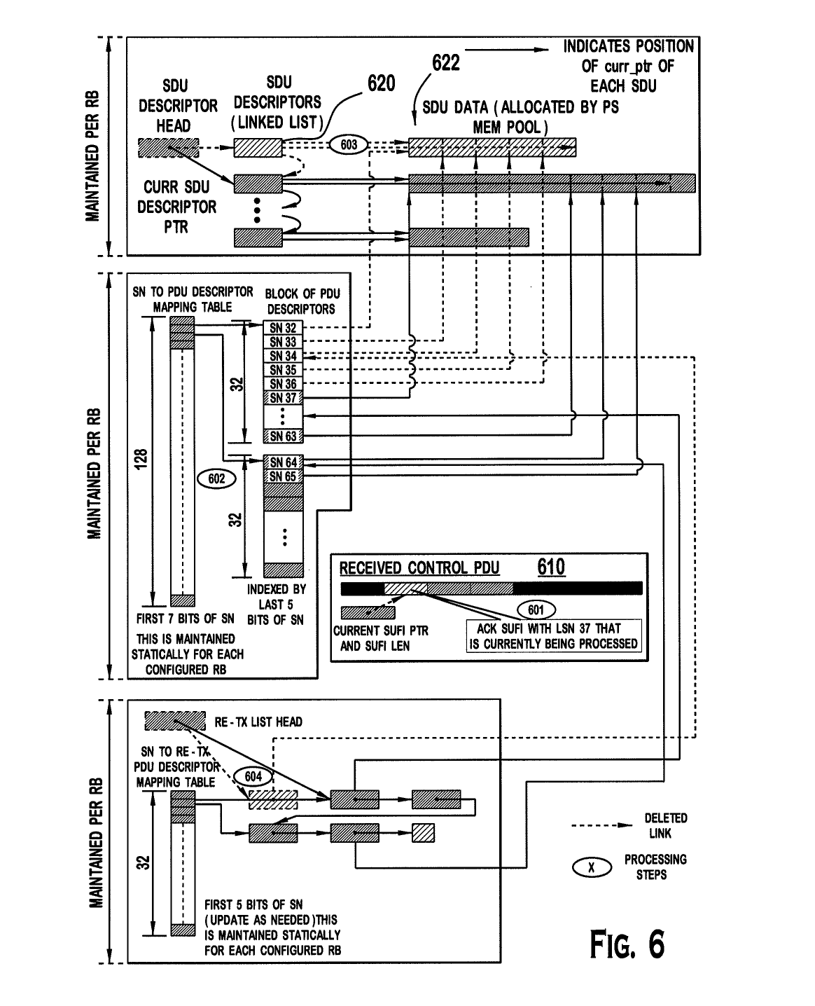

FIG. 6 shows example processing of a control PDU 610 received from the network. A WTRU receives a control PDU 610 shown on the right side (step 601). The control PDU 610 includes an ACK SUFI with a last sequence number (LSN) 37, (i.e., PDUs up to SN=36 are acknowledged). When an ACK is received, the corresponding PDU descriptor is released, but the corresponding block of PDU descriptors may be deleted when the last PDU (for example 32nd PDU) of that block is released. Using the SN-to-PDU descriptor mapping table, the PDU descriptor block for the PDU with SN=36 is accessed (step 602). Since the last acknowledged PDU, (i.e., PDU with SN=36), is not the last PDU of the PDU descriptor block, the PDU descriptor block is not deleted.

Any SDU descriptors and SDU data in the PS memory pool for which the last SN is less than the LSN are deleted, (i.e., returned to the pool). The first outstanding SDU descriptor 620 and SDU data 622 associated with the first SDU descriptor 620 are deleted because the last SN of this SDU descriptor 620 is smaller than the LSN (step 603). The SDU descriptor head is then updated.

The retransmission list may be updated to remove PDUs that are positively acknowledged (ACKed). Assume that a PDU with SN=34 was marked for retransmission from an earlier control PDU. Now the PDU with SN=34 is ACKed. The corresponding PDU descriptor is deleted from the retransmission list and the list is updated (step 604). Buffer occupancy for this RB is updated since retransmission list is updated.

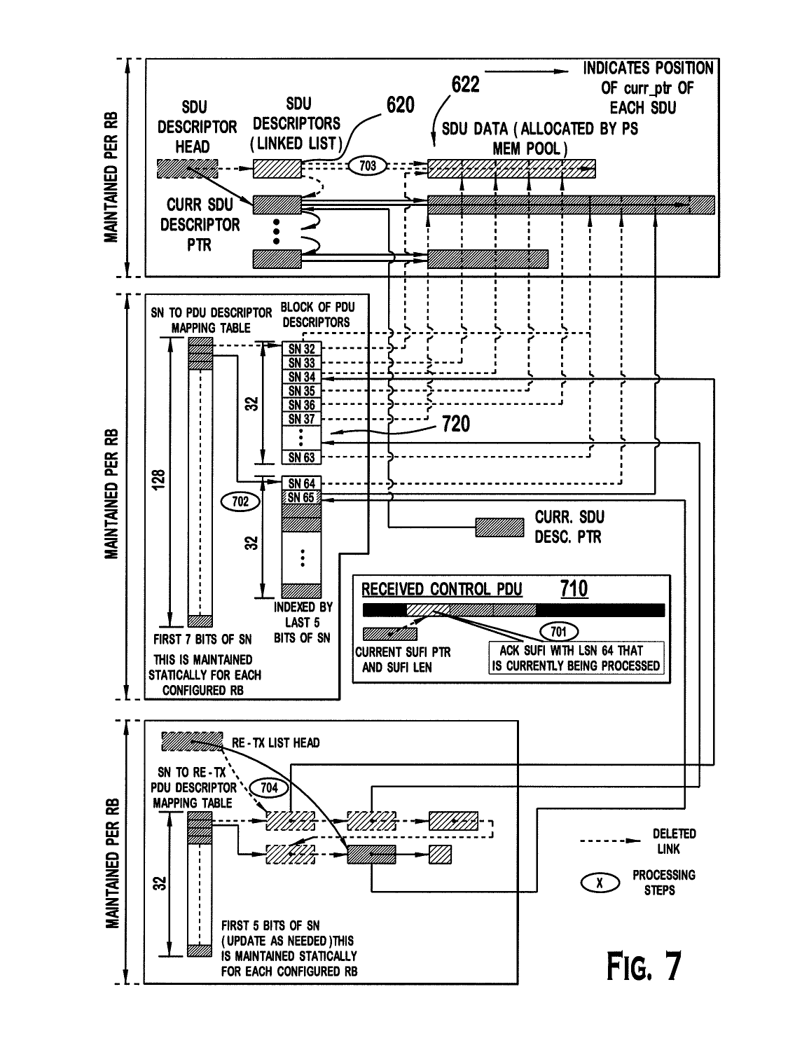

FIG. 7 shows example processing of a subsequently received control PDU from FIG. 6. A control PDU 710 including an ACK SUFI with LSN 64 is received, (i.e., PDUs up to SN=63 are acknowledged) (step 701). Since all PDUs with SN=32 to 63 are released, the corresponding PDU descriptor block 720 (with SNs from 32 to 63) is released to the dynamic pool (step 702). Since there is no SDU descriptor with the last SN smaller than 65 is available, no SDU descriptor or SDU data is deleted (step 703). If there were PDUs with SNs<65 that were marked for retransmission from an earlier control PDU, these PDUs are ACKed and deleted from the retransmission list and the list is updated.

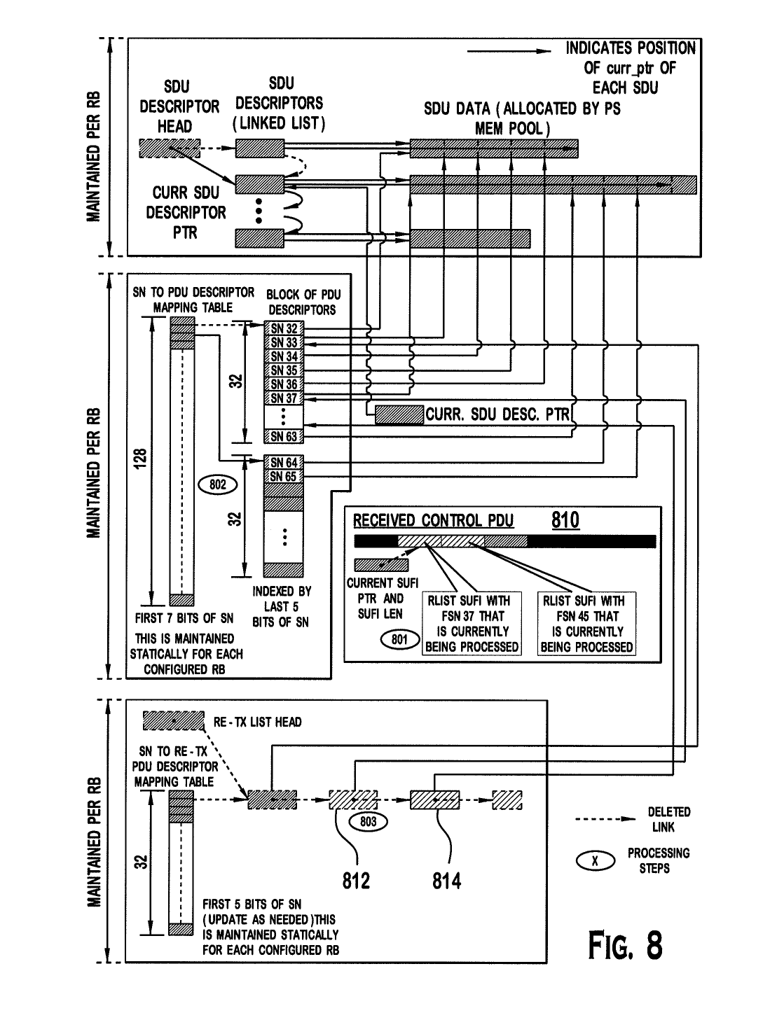

FIG. 8 shows example processing of a control PDU 810 for retransmission. A control PDU 810 with two RLISTs (first RLIST with first sequence number (FSN)=37 and second RLIST with FSN=45) is received for the RB (step 801). Using the SN-to-PDU descriptor mapping table, the pointers to PDU descriptors are obtained based on the SNs (step 802). Two items 812, 814 for the PDUs that are requested to be retransmitted are added to the end of the retransmission list, each pointing the corresponding PDU descriptor (step 803). Buffer occupancy for this RB is updated since the retransmission list is updated.

For each SDU that has either an SDU discard timer expired or any PDU belonging to this SDU has reached maximum number of retransmissions, PDU descriptors with SN less than the last SN of the corresponding SDU descriptor are deleted. Blocks of PDU descriptors are deleted when the last PDU, (e.g., 32nd PDU), of that block is released. The retransmission list is updated to remove PDUs with SN less than the last SN of corresponding SDU descriptor. Corresponding SDU descriptor and SDU data memory are deleted, (i.e., returned to PS pool). If configured to send move receive window (MRW) SUFI, MRW SUFI is created for each RB on which SDU discard occurred.

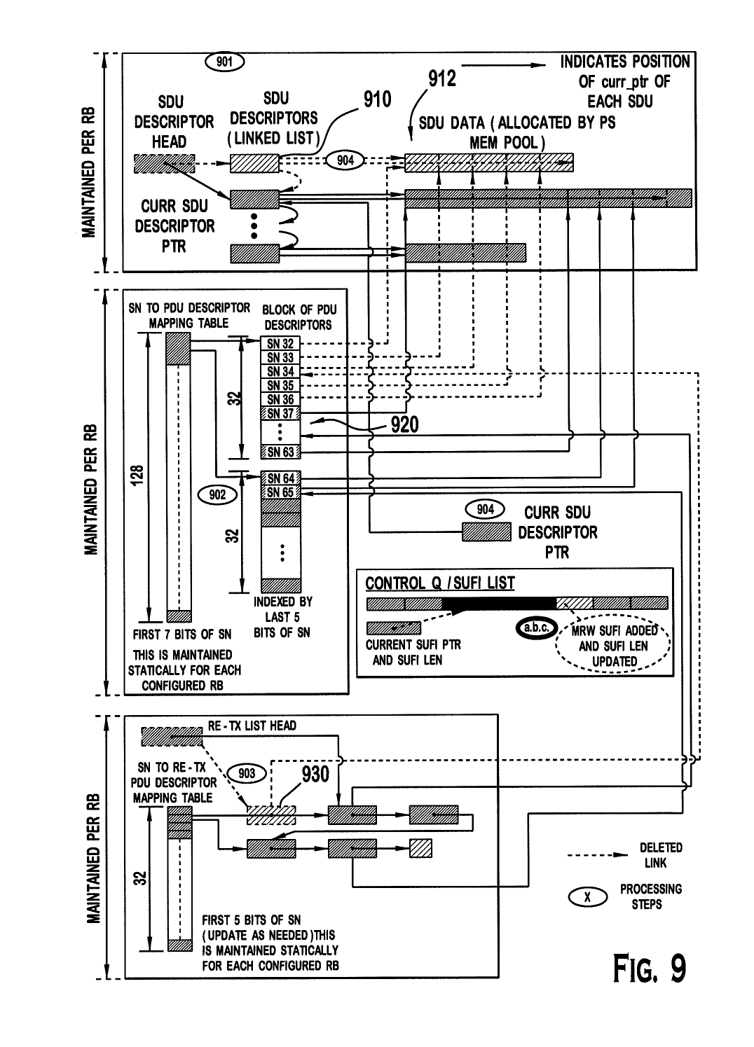

FIG. 9 shows example processing of SDU discard. In this example, an SDU discard timer expired for the first outstanding SDU descriptor 910 (step 901). Last SN of this SDU descriptor 910 is SN=36. Since last SN=36 of this SDU descriptor 910 is not the last PDU of the PDU descriptor block 920, the PDU descriptor block 920 is not deleted (step 902). Assume that a PDU with SN=34 was marked for re-transmission from an earlier control PDU. Now, the PDU with SN=34 is deleted because of SDU discard timer, and the retransmission list is updated by deleting the item 930 for this PDU (step 903). The first outstanding SDU descriptor 910 and SDU data 912 associated with the SDU descriptor 910 are deleted (step 904). The SDU descriptor head is also updated. Buffer occupancy for this RB is updated since the retransmission list is updated.

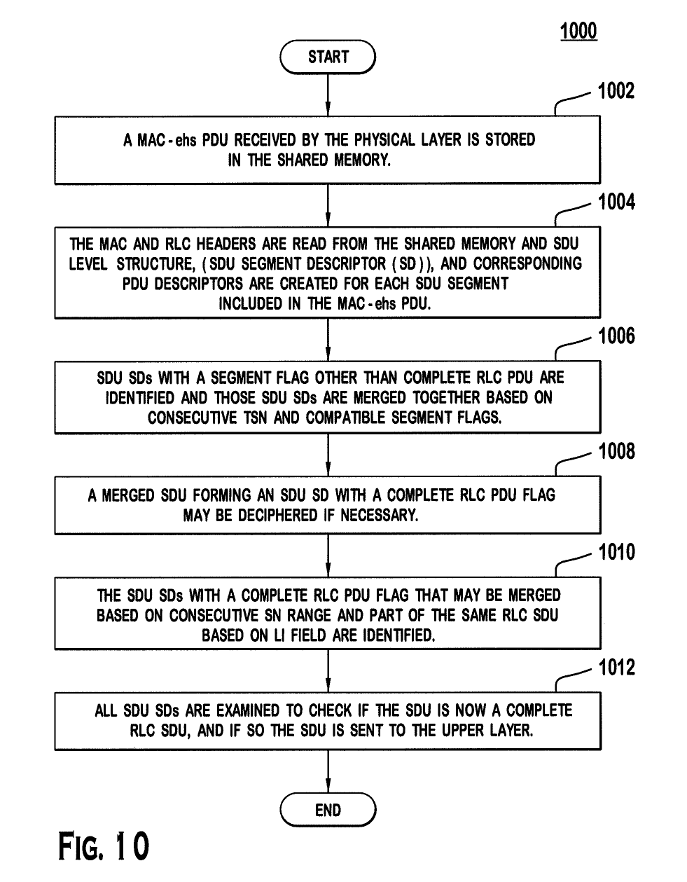

FIG. 10 is a flow diagram of an example receive process 1000 in accordance with one embodiment. MAC-ehs reception processing will be explained as an example. However, it should be noted that the embodiment is applicable to reception of any MAC PDU, such as MAC-d PDU, MAC-hs PDU, or the like.

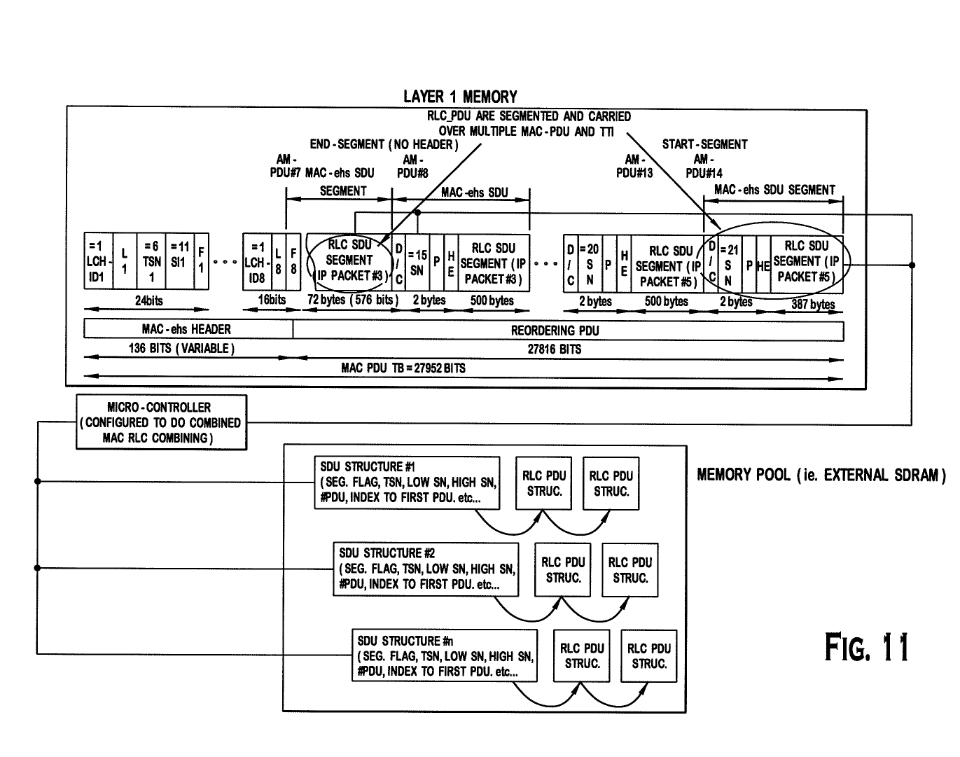

A MAC-ehs PDU, (in Release 6 and earlier, a transport block set), received by the physical layer is stored in the shared memory (step 1002). FIG. 11 shows the MAC-ehs PDU stored in the shared memory. The MAC-ehs PDU includes a MAC-ehs header and one or more reordering PDUs. The reordering PDU includes one or more reordering SDUs. The reordering SDU may be a complete MAC-ehs SDU or MAC-ehs SDU segment.

The MAC-ehs header includes an LCD-ID field, an L field, a transmission sequence number (TSN), a segmentation indication (SI) field and an F field. The LCD-ID field identifies the logical channel of a reordering SDU. The L field provides the length of the reordering SDU. The TSN is used for retransmission and reassembly of the reordering PDU. The SI field indicates whether the MAC-ehs SDU has been segmented. The F field indicates whether more fields are present in the MAC-ehs header. Each reordering SDU, (i.e., RLC SDU segment), has an RLC header. The RLC header includes a D/C field, an SN, a P field, a header extension (HE), an optional length indicator (LI).

The MAC and RLC headers are read from the shared memory and SDU level structure, (i.e., SDU segment descriptor (SD)), and corresponding PDU descriptors are created for each SDU segment included in the MAC-ehs PDU (step 1004). The data received during a 2 ms subframe is streamed from the physical layer shared memory through the PE datapath. The PE parses the stream by pulling off header fields and interpreting the fields to determine what comes next. When the payload area arrives, the stream is redirected to be written into the external memory at a buffer location. After the payload transfer finishes, the parsing of the data streaming from the physical layer shared memory continues. SDU segment descriptors are built in the PE along the way and sent to the external memory. At the end of the 2 ms subframe, a summary of activity is available for the host to retrieve. Most data handling (including all payload data and most control data) is sent to the external memory without the interaction of the host. Only summary information is left in the PE memory for the host to access.

An SDU SD is created at one of the following events: at the start of a MAC-ehs PDU; at the start of a MAC-ehs SDU associated with a new logical channel when more than one logical channel is carried in the same MAC PDU; after a segment is encountered, if this is not the last RLC PDU or segment RLC PDU of the MAC-PDU being processed; when an RLC length indicator (LI) is encountered which means that an RLC SDU is terminated in the middle of the RLC PDU and that a subsequent RLC PDU is part of a new SDU structure; or when RLC PDU SNs are not contiguous.

FIG. 11 shows combined MAC and RLC header parsing and creation of RLC SDU SD and corresponding PDU descriptors. As SDU segments are identified SDU SDs and corresponding PDU descriptors are created and linked.

The SDU SDs are populated with the following fields: a segment flag (SF), lowTSN, highTSN, lowSN, highSN, number of PDU, index to first PDU, index to last PDU, first LI flag, last LI flag.

The SF may take one of the following values:

0: complete RLC PDU;

1: first-segment (end of segment is missing);

2: mid-segment (both start and end of segment is missing); and

3: end-segment (start of segment is missing).

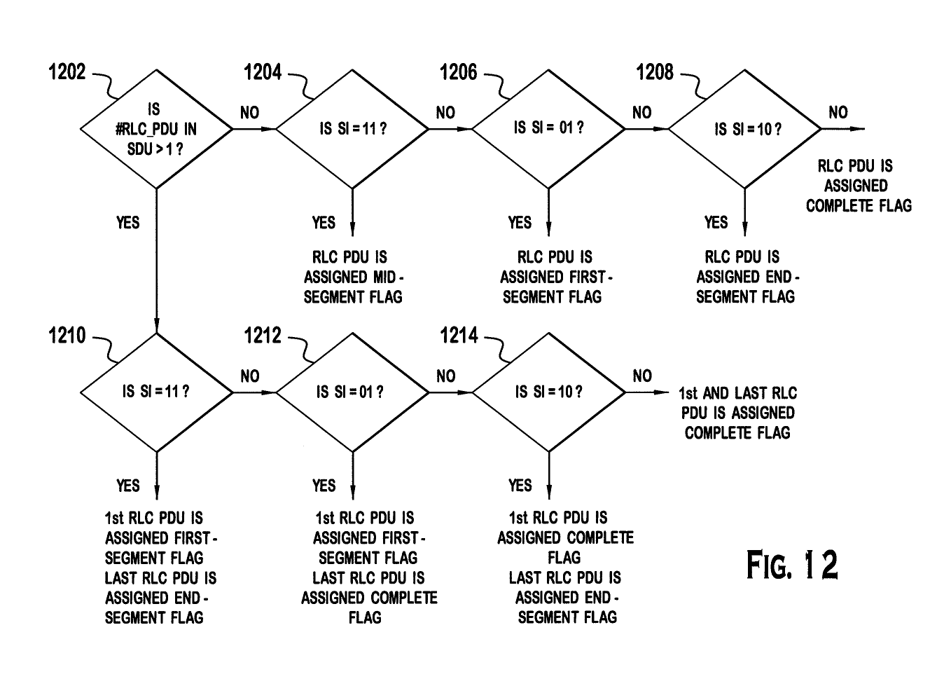

The SF is derived during the combined MAC and RLC processing when first or last RLC PDU is encountered. FIG. 12 shows logic for setting the SF. The segment indication (SI) field in the MAC-ehs header is a 2-bit field indicating whether the MAC-ehs SDU, (i.e., RLC PDU), has been segmented. The SF in the SDU SD is set based on the SI values and the number of reordering SDUs in the reordering PDU.

It is first determined if the number of RLC PDUs in the SDU structure is larger than one or equal to one (step 1202). If it is equal to one, the RLC PDU is assigned a particular SF depending on the value of the SI field as follows. In case the SI is set to ‘11’, the RLC PDU is assigned mid-segment flag (step 1204). In case the SI is set to ‘01’, the RLC PDU is assigned first-segment flag (step 1206). In case the SI is set to ‘10’, the RLC PDU is assigned end-segment flag and in case the SI is set to ‘00’, the RLC PDU is assigned a complete flag (step 1208). If the number of RLC PDUs in the SDU structure is determined to be larger than one at step 1202, the RLC PDU is assigned an SF depending on the value of the SI field as follows. In case the SI is set to ‘11’, the first RLC PDU is assigned a first-segment flag and the last RLC PDU is assigned a last-segment flag (step 1210). In case the SI is set to ‘01’, the first RLC PDU is assigned a first-segment flag and the last RLC PDU is assigned a complete flag (step 1212). In case the SI is set to ‘10’, the first RLC PDU is assigned a complete flat and the last RLC PDU is assigned an end-segment flag (step 1214). In case the SI is set to ‘00’, the first and last RLC PDUs are assigned a complete flag (step 1214).

Both the lowTSN and the highTSN are initially set to the TSN value captured in the MAC-ehs header and are updated respectively as the SDU SDs are merged. Both lowSN and highSN are initially set to the SN value in the RLC header for the SDU segment, and are updated respectively as SDU SDs are merged. The information in the SDU SD makes it easy for the host to re-order the SDU segments into a complete SDU with the least amount of processing as possible.

PDU descriptors are populated during the combined MAC and RLC processing with the following fields: SN, num_of_bits, index to next PDU, and pointer to PDU data. The SN field is systematically populated with the first 2 bytes of the reordering SDU, (i.e., MAC-ehs SDU or MAC-ehs SDU segment). Value stored will most likely be valid only for the first segment or complete RLC PDU. Not valid values will be discarded during the merging phase.

Referring again to FIG. 10, SDU SDs with a segment flag other than complete RLC PDU are identified and those SDU SDs are merged together based on consecutive TSN and compatible segment flags, (e.g., two first segments cannot be merged together) (step 1006). After merging the SDU SDs, the following fields are updated: TSN range (lowTSN, highTSN), SI field (first-segment merged with mid-segment becomes first-segment, end-segment merged with mid-segment becomes end-segment, first-segment merged with end-segment becomes a complete RLC PDU), the number of bits (simply added), and the pointer to next PDU (updated in the PDU descriptor as a linked chain). The merging does not need to be performed at the PDU level which saves considerably host processor processing. The SDU SDs may be grouped per logical channel, and the merging steps may be repeated for each logical channel. A merged SDU forming an SDU SD with a complete RLC PDU flag may be deciphered if necessary (step 1008). Deciphering may be performed as the data moves from the physical layer shared memory to the external memory.

The SDU SDs with a complete RLC PDU flag that may be merged based on consecutive SN range and part of the same RLC SDU based on LI field are identified (step 1010). The identified SDU SDs are merged and the following fields are updated: SN range (lowSN, highSN), LI field, number of PDU, pointer to the next PDU in the PDU descriptor. All SDU SDs are examined to check if the SDU is now a complete RLC SDU, and if so the SDU is sent to the upper layer, (e.g., RRC, PDCP, etc.) (step 1012).

Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module.

What is claimed is:

1. A method for combined medium access control (MAC) and radio link control (RLC) processing, the method comprising:
storing an RLC service data unit (SDU) forwarded from a higher layer;
generating an SDU descriptor for the SDU;
generating a corresponding protocol data unit (PDU) descriptor for each PDU carrying at least a portion of the SDU; and
generating a MAC PDU based on the SDU descriptor and the PDU descriptor.

2. The method of claim 1 wherein PDU descriptor resources are allocated and deallocated block by block.

3. The method of claim 2 wherein a PDU descriptor block is mapped using an RLC sequence number (SN).

4. The method of claim 1 wherein the MAC PDU is stored in a physical layer shared memory and the RLC SDU is stored in a second memory, and the MAC PDU is generated while moving RLC SDU data from the second memory to the physical layer shared memory.

5. The method of claim 1 further comprising:
receiving a control PDU including a last sequence number (LSN) that is positively acknowledged;
deleting a corresponding PDU descriptor block if a sequence number of a last PDU descriptor in the PDU descriptor block is less than the LSN; and
deleting an SDU descriptor and an RLC SDU if a last sequence number of the RLC SDU is less than the LSN.

6. The method of claim 1 further comprising:
setting a discard timer when the RLC SDU is transmitted;
upon expiration of the discard timer, deleting an SDU descriptor and the RLC SDU; and
deleting a corresponding PDU descriptor block if a sequence number of a last PDU descriptor in the PDU descriptor block is less than a last sequence number of the RLC SDU.

7. A method for combined medium access control (MAC) and radio link control (RLC) processing, the method comprising:
receiving a MAC protocol data unit (PDU);
reading MAC and RLC headers in the MAC PDU and generating a SDU segment descriptor (SD) and corresponding PDU descriptors for each SDU segment included in the MAC PDU based on the MAC and RLC headers, the SDU SD including a segment flag indicating whether an RLC PDU has been segmented or not;
merging SDU SDs with a segment flag other than “complete RLC PDU” that comprise a same RLC PDU, a segment flag of the merged SD being updated to “complete RLC PDU”;
merging SDU SDs with a segment flag of “complete RLC PDU” that comprise a same RLC SDU; and
sending a complete RLC SDU to a higher layer.

8. The method of claim 7 further comprising:
deciphering an RLC PDU forming an SDU SD with a segment flag of “complete RLC PDU”.

9. A wireless transmit/receive unit (WTRU) for combined medium access control (MAC) and radio link control (RLC) processing, the WTRU comprising:
a second memory for storing an RLC service data unit (SDU) forwarded from a higher layer;
a combined MAC/RLC (CMR) entity for generating an SDU descriptor for the SDU and allocating protocol data unit (PDU) descriptor resource for the RLC SDU; and
a protocol engine (PE) for populating a PDU descriptor for each PDU carrying at least a portion of the SDU and generating a MAC PDU in a physical layer shared memory based on the SDU descriptor and the PDU descriptor.

10. The WTRU of claim 9 wherein PDU descriptor resources are allocated and deallocated block by block.

11. The WTRU of claim 10 wherein a PDU descriptor block is mapped based on a sequence number (SN).

12. The WTRU of claim 9 wherein the MAC PDU is stored in a physical layer shared memory and the MAC PDU is generated while moving RLC SDU data from the second memory to the physical layer shared memory.

13. The WTRU of claim 9 wherein the CMR entity is configured to delete a corresponding PDU descriptor block if a sequence number of a last PDU descriptor in the PDU descriptor block is less than a last sequence number (LSN) that is positively acknowledged by a control PDU, and delete an SDU descriptor and an RLC SDU if a last sequence number of the RLC SDU is less than the LSN.

14. The WTRU of claim 9 wherein the CMR entity is configured to, upon expiration of a discard timer for the RLC SDU, delete an SDU descriptor and the RLC SDU, and delete a corresponding PDU descriptor block if a sequence number of a last PDU descriptor in the PDU descriptor block is less than a last sequence number of the RLC SDU.

15. A wireless transmit/receive unit (WTRU) for combined medium access control (MAC) and radio link control (RLC) processing, the WTRU comprising:
a physical layer shared memory for storing a received MAC protocol data unit (PDU);
a protocol engine (PE) for reading MAC and RLC headers in the MAC PDU and populating a service data unit (SDU) segment descriptor (SD) and corresponding PDU descriptors for each SDU segment included in the MAC PDU based on the MAC and RLC headers, the SDU SD including a segment flag indicating whether an RLC PDU has been segmented or not; and
a combined MAC/RLC (CMR) entity for merging SDU SDs with a segment flag other than “complete RLC PDU” that comprise a same RLC PDU, a segment flag of the merged SD being updated to “complete RLC PDU”, merging SDU SDs with a segment flag of “complete RLC PDU” that comprise a same RLC SDU, and sending a complete RLC SDU to a higher layer.

16. The WTRU of claim 15 wherein the CMR entity deciphers an RLC PDU forming an SDU SD with a segment flag of “complete RLC PDU”.
